(19) United States
(12) Patent Application Publication
(10) Pub. No.: US 2024/0353907 A1
(43) Pub. Date: Oct. 24, 2024

(54) SYSTEM-ON-CHIP INCLUDING VOLTAGE DROOP DETECTION CIRCUIT AND OPERATING METHOD THEREOF

(71) Applicant: SAMSUNG ELECTRONICS CO., LTD., SUWON-SI (KR)

(72) Inventors: Yunjeong KIM, Suwon-si (KR); Takahiro Nomiyama, Suwon-si (KR)

(21) Appl. No.: 18/640,103

(22) Filed: Apr. 19, 2024

(30) Foreign Application Priority Data
Apr. 20, 2023 (KR) 10-2023-0052213
Jul. 19, 2023 (KR) 10-2023-0094020

(51) Int. Cl. G06F 1/28; G06F 1/08; G06F 1/14

(52) U.S. Cl. CPC G06F 1/28; G06F 1/08; G06F 1/14

(57) ABSTRACT

A system-on-chip includes a functional circuit, a voltage droop detection circuit, a clock generation circuit, and a clock modulation. The voltage droop detection circuit includes a voltage droop detection controller, a reference voltage generator, and a detection signal generator.

### CROSS-REFERENCE TO RELATED APPLICATIONS

This application claims priority under 35 U.S.C. § 119 to Korean Patent Application Nos. 10-2023-0052213, filed on Apr. 20, 2023, and 10-2023-0094020, filed on Jul. 19, 2023, in the Korean Intellectual Property Office, the disclosures of which are incorporated by reference herein in their entireties.

### TECHNICAL FIELD

Embodiments of the inventive concept relate to a semiconductor circuit, and more particularly, to a system-on-chip including a voltage droop detection circuit and an operating method thereof.

### DISCUSSION OF RELATED ART

A supply voltage of a high-performance functional circuit (or a semiconductor circuit) included in a system-on-chip (SoC) fluctuates according to an operating environment and a level of performed work. Generally, to prepare for a droop in which a voltage significantly drops, a method is used in which a guard band is set on a supply voltage so that the supply voltage has a value greater than a value utilized in a normal state. A guard band refers to a value additionally added to a value of a supply voltage in a normal state while taking droop into account. However, power consumption of an SoC increases due to the setting of a high guard band, and thus, the efficiency of a product may be decreased.

### SUMMARY

Embodiments of the inventive concept provide a system-on-chip including a voltage droop detection circuit that may provide efficient power consumption of a functional circuit by controlling the frequency of an adaptive clock signal provided to the functional circuit when droop of a supply voltage has been detected, and an operating method of the system-on-chip.

According to an aspect of embodiments of the inventive concept, there is provided a system-on-chip including a functional circuit configured to receive a supply voltage and perform a processing operation, a voltage droop detection circuit configured to monitor the supply voltage and generate a detection signal indicating whether a voltage droop has occurred, a clock generation circuit configured to output a clock signal, and a clock modulation circuit configured to receive the detection signal and the clock signal, generate an adaptive clock signal by modulating the clock signal to correspond to the detection signal, and provide the adaptive clock signal to the functional circuit. The voltage droop detection circuit includes a voltage droop detection controller configured to control a reference voltage to remain constant, a reference voltage generator configured to generate the reference voltage, and a detection signal generator configured to generate the detection signal by comparing the reference voltage with the supply voltage to generate the detection signal.

According to an aspect of embodiments of the inventive concept, there is provided an operating method of a system-on-chip, including monitoring, by a voltage droop detection circuit included in the system-on-chip, the supply voltage. The supply voltage is received by a functional circuit included in the system-on-chip, and the functional circuit is configured to perform a processing operation. The method further includes comparing a level of the supply voltage with a level of a reference voltage, generating a detection signal based on a result of the comparison, and adjusting a frequency of a clock signal based on the detection signal.

According to an aspect of embodiments of the inventive concept, there is provided a system-on-chip including a first functional circuit configured to receive a supply voltage and perform a first processing operation, a first voltage droop detection circuit configured to monitor the supply voltage and generate a first detection signal indicating whether a voltage droop has occurred, a second functional circuit configured to receive the supply voltage and perform a second processing operation, a second voltage droop detection circuit configured to monitor the supply voltage and generate a second detection signal indicating whether the voltage droop has occurred, a clock generation circuit configured to output a clock signal, and a clock modulation circuit. The clock modulation circuit is configured to receive the first and second detection signals and the clock signal, generate a first adaptive clock signal and a second adaptive clock signal by modulating the clock signal to correspond to the first and second detection signals, respectively, and provide the first adaptive clock signal and the second adaptive clock signal to the first functional circuit and the second functional circuit, respectively. The first voltage droop detection circuit includes a first controller configured to control a first reference voltage to remain constant, a first reference voltage generator configured to generate the first reference voltage, a first detection signal generator configured to generate the first detection signal by comparing the first reference voltage with the supply voltage. The second voltage droop detection circuit includes a second controller configured to control a second reference voltage to remain constant, a second reference voltage generator configured to generate the second reference voltage, and a second detection signal generator configured to generate the second detection signal by comparing the reference voltage with the supply voltage.

### BRIEF DESCRIPTION OF THE DRAWINGS

The above and other features of the inventive concept will become more apparent by describing in detail embodiments thereof with reference to the accompanying drawings, in which:

FIG. 1 is a block diagram schematically illustrating a system-on-chip according to an embodiment;

FIG. 2 is a block diagram illustrating in detail a system-on-chip according to an embodiment;

FIG. 3 is a block diagram illustrating a voltage droop detection circuit according to an embodiment;

FIG. 4 is a block diagram illustrating a reference voltage generator according to an embodiment;

FIG. 5 is a block diagram illustrating a clock modulation circuit according to an embodiment;

FIG. 6 is a graph illustrating an operation of a voltage droop detection circuit according to an embodiment;

FIGS. 7A and 7B are graphs each showing a droop voltage level according to temperature characteristics of an element of a functional circuit according to an embodiment;

FIG. 8 is a diagram illustrating a method of adjusting a reference voltage according to an embodiment;

FIG. 9 is a flowchart illustrating an operating method of a system-on-chip according to an embodiment;

FIG. 10 is a flowchart illustrating an operating method of a system-on-chip according to an embodiment;

FIG. 11 is a block diagram illustrating a system-on-chip according to an embodiment;

FIG. 12 is a block diagram illustrating a system-on-chip according to an embodiment;

FIG. 13 is a block diagram illustrating a data processing system including a system-on-chip according to an embodiment; and

FIG. 14 is a block diagram illustrating a mobile system including a system-on-chip according to an embodiment.

### DETAILED DESCRIPTION OF THE EMBODIMENTS

Embodiments of the inventive concept will be described more fully hereinafter with reference to the accompanying drawings. Like reference numerals may refer to like elements throughout the accompanying drawings.

It will be understood that the terms “first,” “second,” “third,” etc. are used herein to distinguish one element from another, and the elements are not limited by these terms. Thus, a “first” element in an embodiment may be described as a “second” element in another embodiment.

It should be understood that descriptions of features or aspects within each embodiment should typically be considered as available for other similar features or aspects in other embodiments, unless the context clearly indicates otherwise.

As used herein, the singular forms “a”, “an” and “the” are intended to include the plural forms as well, unless the context clearly indicates otherwise.

Herein, when two or more elements or values are described as being substantially the same as or about equal to each other, it is to be understood that the elements or values are identical to each other, the elements or values are equal to each other within a measurement error, or if measurably unequal, are close enough in value to be functionally equal to each other as would be understood by a person having ordinary skill in the art. For example, the term “about” as used herein is inclusive of the stated value and means within an acceptable range of deviation for the particular value as determined by one of ordinary skill in the art, considering the measurement in question and the error associated with measurement of the particular quantity (e.g., the limitations of the measurement system). For example, “about” may mean within one or more standard deviations as understood by one of the ordinary skill in the art. Further, it is to be understood that while parameters may be described herein as having “about” a certain value, according to embodiments, the parameter may be exactly the certain value or approximately the certain value within a measurement error as would be understood by a person having ordinary skill in the art. Other uses of these terms and similar terms to describe the relationships between components should be interpreted in a like fashion.

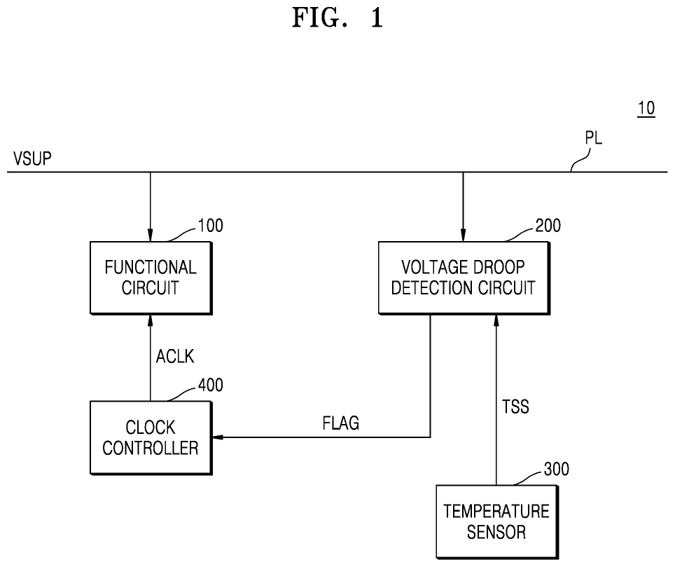

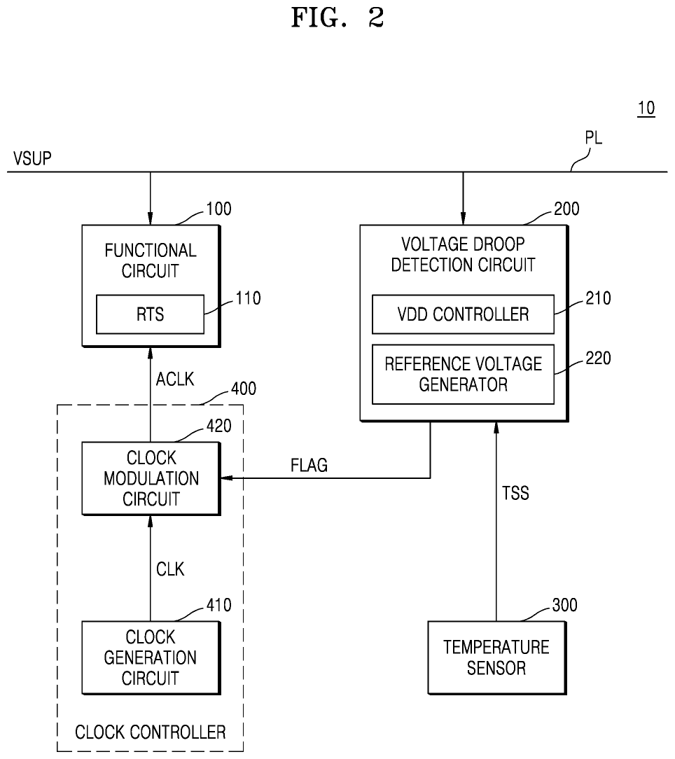

FIG. 1 is a block diagram schematically illustrating a system-on-chip 10 according to an embodiment. FIG. 2 is a block diagram illustrating in detail the system-on-chip 10 according to an embodiment. The system-on-chip 10 of FIG. 1 may be referred to as an adaptive clock system.

Referring to FIG. 1, the system-on-chip 10 may include a functional circuit 100, a voltage droop detection circuit 200, a temperature sensor 300, and a clock controller 400.

In more detail, referring to FIG. 2, the functional circuit 100 may include a remote temperature sensor (RTS) 110, the voltage droop detection circuit 200 may include a voltage droop detection (VDD) controller 210 and a reference voltage generator 220, and the clock controller 400 may include a clock generation circuit 410 and a clock modulation circuit 420.

Referring to FIGS. 1 and 2 together, the functional circuit 100 may perform a certain processing operation by receiving a supply voltage VSUP through a power line PL. In an embodiment, the functional circuit 100 may be implemented as hardware such as, for example, a central processing unit, a graphics processing unit, a processor, a modem, or the like. The RTS 110 may be a sensor that measures the temperature inside the functional circuit 100.

The voltage droop detection circuit 200 may monitor the supply voltage VSUP through the power line PL and may generate and provide a detection signal FLAG indicating whether droop of the supply voltage VSUP has occurred to the clock modulation circuit 420.

In an embodiment, the voltage droop detection circuit 200 may generate a high-level detection signal FLAG when the supply voltage VSUP falls below a reference voltage. For example, the voltage droop detection circuit 200 may use a plurality of reference voltages having different levels to generate the detection signal FLAG including a plurality of bits to indicate the occurrence of droop of the supply voltage VSUP and a degree of the occurred droop.

The temperature sensor 300 may measure the temperature inside the system-on-chip 10. In some embodiments, the temperature sensor 300 may measure the temperature of the functional circuit 100. Temperature is a parameter that affects the operation of the functional circuit 100. When the temperature is too high, it may be difficult for the functional circuit 100 to smoothly perform a processing operation in synchronization with an adaptive clock signal ACLK having high frequency. Accordingly, the clock modulation circuit 420 may lower the frequency of the adaptive clock signal ACLK when the temperature is about equal to or greater than a reference temperature, according to embodiments of the inventive concept described above. The temperature sensor 300 may generate a temperature sensing signal TSS indicating a temperature state of the system-on-chip 10.

In an embodiment, the voltage droop detection circuit 200 may generate the detection signal FLAG based on the temperature sensing signal TSS received from the temperature sensor 300.

The system-on-chip 10 may further include at least one sensor for sensing parameters which affect the operation of the functional circuit 100, in addition to the temperature sensor 300, and the clock modulation circuit 420 may perform an operation of modulating the frequency of a clock signal CLK based on the detection signal FLAG received from the voltage droop detection circuit 200.

The clock generation circuit 410 may generate a clock signal CLK having a frequency corresponding to an operating frequency of the functional circuit 100 when a supply voltage VSUP in a normal state is provided to the functional circuit 100. The clock generation circuit 410 may be implemented as, for example, a phase-locked loop (PLL) or a frequency-locked loop (FLL).

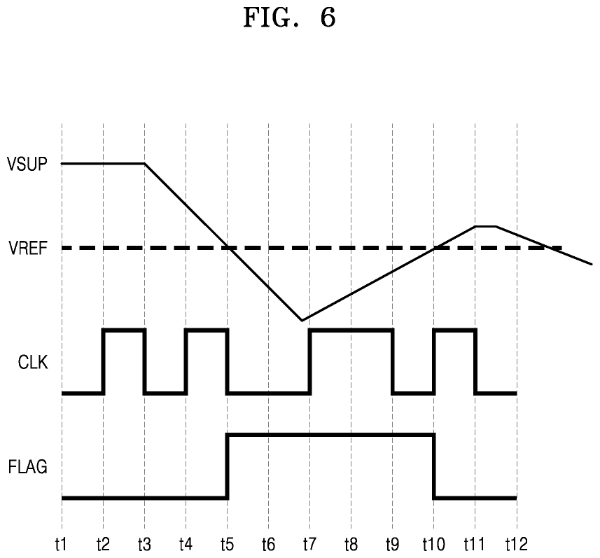

The clock modulation circuit 420 may receive the detection signal FLAG and the clock signal CLK, generate an adaptive clock signal ACLK by modulating the clock signal CLK to correspond to the detection signal FLAG, and provide the adaptive clock signal ACLK to the functional circuit 100. In an embodiment, the clock modulation circuit 420 may adjust the frequency of the adaptive clock signal ACLK according to a degree of droop of the supply voltage VSUP. As the degree of droop increases, the clock modulation circuit 420 may set the frequency of the adaptive clock signal ACLK to be lower than the frequency of the clock signal CLK, and may adaptively adjust the frequency of the adaptive clock signal ACLK according to an operating environment and level of performed work of the functional circuit 100, as described further with reference to FIGS. 6 to 8.

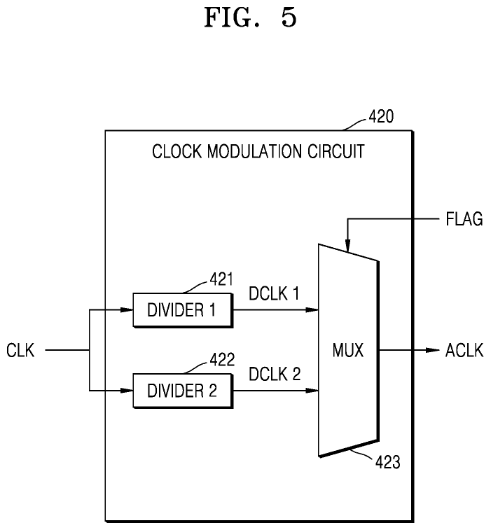

In an embodiment, the clock modulation circuit 420 may divide or multiplex the clock signal CLK in response to the detection signal FLAG to adjust the frequency of the clock signal CLK, thereby providing the adaptive clock signal ACLK. To this end, the clock modulation circuit 420 may include a plurality of frequency dividers and a multiplexer. Each of the plurality of frequency dividers may divide the frequency of the clock signal CLK, and the multiplexer may output at least one output of the plurality of frequency dividers to the adaptive clock signal ACLK. A detailed configuration of the clock modulation circuit 420 is described with reference to FIG. 5.

The clock controller 400 according to an embodiment may modulate the frequency of the clock signal CLK to a low level when droop of the supply voltage VSUP has occurred, and provide the clock signal CLK having a modulated frequency to the functional circuit 100.

The functional circuit 100 performs a processing operation based on the adaptive clock signal ACLK having a frequency lower than before when droop of the supply voltage VSUP has occurred, so that power consumption of the functional circuit 100 may be reduced for a certain period of time. Accordingly, the system-on-chip 10 may perform a stable operation as the drooped supply voltage VSUP is quickly recovered, and a guard band applied to the supply voltage VSUP may be reduced to reduce the overall amount of power consumed by the system-on-chip 10.

That is, when droop (voltage drop) has occurred in the supply voltage VSUP, the system-on-chip 10 of FIG. 1 may detect the droop to change the frequency of the clock signal CLK by using the clock modulation circuit 420, thereby allowing the functional circuit 100 to operate at a low voltage.

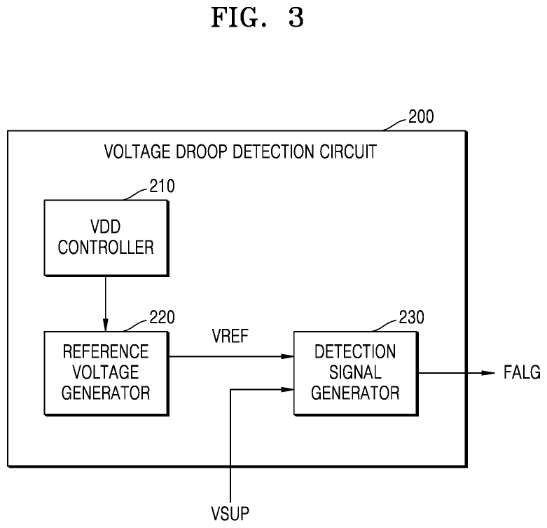

FIG. 3 is a block diagram illustrating the voltage droop detection circuit 200 according to an embodiment.

Referring to FIG. 3, the voltage droop detection circuit 200 may include the VDD controller 210, the reference voltage generator 220, and a detection signal generator 230.

The VDD controller 210 may control an overall operation in which the voltage droop detection circuit 200 detects whether droop of the supply voltage VSUP has occurred.

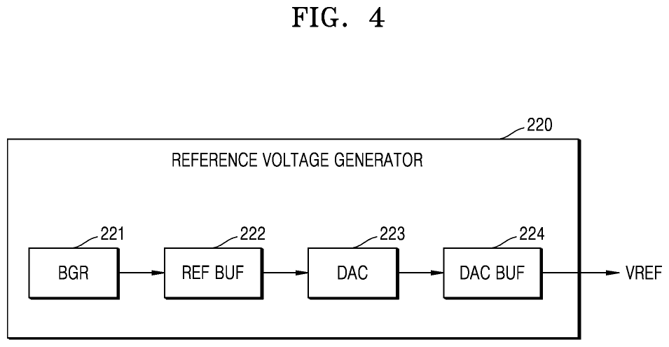

The reference voltage generator 220 may provide a reference voltage VREF to the detection signal generator 230 in response to a control signal of the VDD controller 210. For example, the reference voltage generator 220 may provide a plurality of reference voltages VREF to the detection signal generator 230. A detailed configuration of the reference voltage generator 220 is described below with reference to FIG. 4.

The detection signal generator 230 may determine whether droop has occurred by checking whether the supply voltage VSUP is less than the reference voltage VREF. The detection signal generator 230 may generate and provide the detection signal FLAG to the clock modulation circuit 420 of FIG. 2 based on a determination result. For example, the detection signal generator 230 may compare the supply voltage VSUP with each of the plurality of reference voltages VREF to specifically determine the magnitude of the supply voltage VSUP, thereby generating the detection signal FLAG including a plurality of bits indicating a degree of droop of the supply voltage VSUP when the droop has occurred. Also, the detection signal generator 230 may include a comparator that compares the supply voltage VSUP with the reference voltage VREF.

FIG. 4 is a block diagram illustrating the reference voltage generator 220 according to an embodiment.

Referring to FIG. 4, the reference voltage generator 220 may include a band gap reference (BGR) circuit 221, a reference voltage buffer 222, a digital-to-analog converter (DAC) 223, and a DAC buffer 224.

The BGR circuit 221 may generate a band gap reference voltage. The reference voltage buffer 222 may receive the band gap reference voltage and output a DAC reference voltage. The DAC 223 may convert the DAC reference voltage into an analog reference voltage according to input code. The DAC 223 may output the analog reference voltage. The DAC buffer 224 may output the analog reference voltage VREF.

For example, the BGR circuit 221 may generate a band gap reference voltage of about 0.35 V, and the reference voltage buffer 222 may output a DAC reference voltage of about 0.8 V. The DAC 223 may receive the DAC reference voltage and convert the same into an analog reference voltage to output the analog reference voltage of about 0 V to about 0.8 V. The DAC buffer 224 may output the analog reference voltage VREF of about 0 V to about 0.8 V.

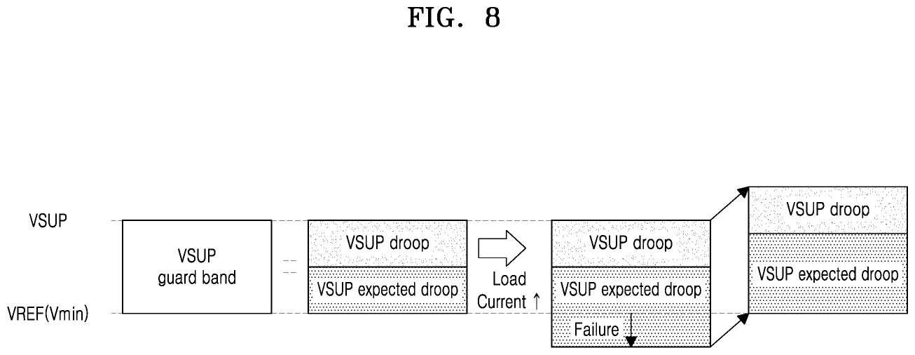

A method in which the reference voltage generator 220 adjusts a reference voltage is described below with reference to FIG. 8.

FIG. 5 is a block diagram illustrating the clock modulation circuit 420 according to an embodiment.

Referring to FIG. 5, the clock modulation circuit 420 may include a plurality of frequency dividers 421 and 422 and a multiplexer 423.

The plurality of frequency dividers 421 and 422 may receive the clock signal CLK and divide the clock signal CLK by different division rates from each other to generate a first divided clock signal DCLK1 and a second divided clock signal DCLK2, which have different frequencies from each other. For example, the frequencies of the first divided clock signal DCLK1 and the second divided clock signal DCLK2 may be about equal to the frequency of the clock signal CLK, or the frequencies of the first divided clock signal DCLK1 and the second divided clock signal DCLK2 may be less than the frequency of the clock signal CLK.

FIG. 5 shows a case where the clock modulation circuit 420 includes two frequency dividers 421 and 422, but the clock modulation circuit 420 is not limited thereto and may include any number of frequency dividers.

The multiplexer 423 may output any one of the first divided clock signal DCLK1 and the second divided clock signal DCLK2 as the adaptive clock signal ACLK, in response to the detection signal FLAG.

For example, the multiplexer 423 may select and output the first divided clock signal DCLK1 as the adaptive clock signal ACLK when droop of a supply voltage has occurred. The frequency of the first divided clock signal DCLK1 may be less than the frequency of the clock signal CLK. When the first divided clock signal DCLK1 is selected and output as the adaptive clock signal ACLK, the frequency of the adaptive clock signal ACLK output may be less than the frequency of the clock signal CLK.

The multiplexer 423 may select and output the second divided clock signal DCLK2 as the adaptive clock signal ACLK when droop of a supply voltage has not occurred. Herein, the second divided clock signal DCLK2 may be a clock signal having a frequency about equal to the frequency of the clock signal CLK.

The clock modulation circuit 420 shown in FIG. 5 may adaptively adjust a frequency ratio according to various factors such as, for example, a degree of droop of a supply voltage, an operating environment of a functional circuit, or the like.

FIG. 6 is a graph illustrating an operation of the voltage droop detection circuit 200 according to an embodiment.

Referring to FIGS. 2, 3, and 6 together, because a level of the supply voltage VSUP is greater than a level of the reference voltage VREF at a first time point t1, the detection signal FLAG may be at a first logic level (e.g., low level). The clock signal CLK output by the clock generation circuit 410 may be at the first logic level.

Because the level of the supply voltage VSUP is still greater than the level of the reference voltage VREF at a second time point t2, the detection signal FLAG may remain at the first logic level. The clock signal CLK output by the clock generation circuit 410 may transition to a second logic level (e.g., high level).

Although the level of the supply voltage VSUP decreases at a third time point t3, the level of the supply voltage VSUP is greater than the level of the reference voltage VREF, and thus, the detection signal FLAG may remain at the first logic level. The clock signal CLK output by the clock generation circuit 410 may transition to the first logic level.

Although the level of the supply voltage VSUP decreases at a fourth time point t4, the level of the supply voltage VSUP is greater than the level of the reference voltage VREF, and thus, the detection signal FLAG may remain at the first logic level. The clock signal CLK output by the clock generation circuit 410 may transition to the second logic level.

Because the level of the supply voltage VSUP decreases and becomes less than the level of the reference voltage VREF at a fifth time point t5, the detection signal FLAG may transition to the second logic level.

That is, the detection signal generator 230 may compare the reference voltage VREF with the supply voltage VSUP, which is drooped, at the fifth time point t5 to generate the detection signal FLAG based on a comparison result. For example, when the level of the supply voltage VSUP, which is drooped, is less than the level of the reference voltage VREF, the detection signal generator 230 may generate the detection signal FLAG at the second logic level (e.g., high level) indicating a state of the drooped supply voltage VSUP.

The clock modulation circuit 420 may receive the detection signal FLAG at the fifth time point t5 and modulate the clock signal CLK. For example, the clock modulation circuit 420 may divide the frequency of the clock signal CLK to allow the clock signal CLK to remain at the first logic level without transitioning to the second logic level.

Because the level of the supply voltage VSUP is still less than the level of the reference voltage VREF at a sixth time point t6, the detection signal FLAG may remain at the second logic level, and the clock signal CLK may also remain at the first logic level.

Because the level of the supply voltage VSUP is still less than the level of the reference voltage VREF at a seventh time point t7, the detection signal FLAG may remain at the second logic level, and the clock signal CLK may transition to the second logic level.

The clock modulation circuit 420 may transition the clock signal CLK to the second logic level at the seventh time point t7 to modulate the frequency of the clock signal CLK and provide the adaptive clock signal ACLK to the functional circuit 100. That is, the functional circuit 100 may perform a processing operation based on the adaptive clock signal ACLK having a lower frequency than the frequency of the clock signal CLK, thereby being able to operate at a low voltage and also reducing power consumption.

Because the level of the supply voltage VSUP is still less than the level of the reference voltage VREF at an eighth time point t8, the detection signal FLAG may remain at the second logic level, and the clock signal CLK may also remain at the second logic level.

Because the level of the supply voltage VSUP is still less than the level of the reference voltage VREF at a ninth time point t9, the detection signal FLAG may remain at the second logic level, and the clock signal CLK may transition to the first logic level.

The clock modulation circuit 420 may transition the clock signal CLK to the first logic level at the ninth time point t9 to modulate the frequency of the clock signal CLK and provide the adaptive clock signal ACLK to the functional circuit 100. That is, the functional circuit 100 may perform a processing operation based on the adaptive clock signal ACLK having a lower frequency than the frequency of the clock signal CLK, thereby being able to operate at a low voltage and also reducing power consumption.

Because the level of the supply voltage VSUP is about equal to the level of the reference voltage VREF at a tenth time point t10, the detection signal FLAG may transition to the first logic level. The clock signal CLK may also transition to the second logic level.

Because the level of the supply voltage VSUP is greater than the level of the reference voltage VREF at an eleventh time point t11, the detection signal FLAG may remain at the first logic level. The clock signal CLK may transition to the first logic level.

A twelfth time point t12 may remain at the same state as that of the eleventh time point t11.

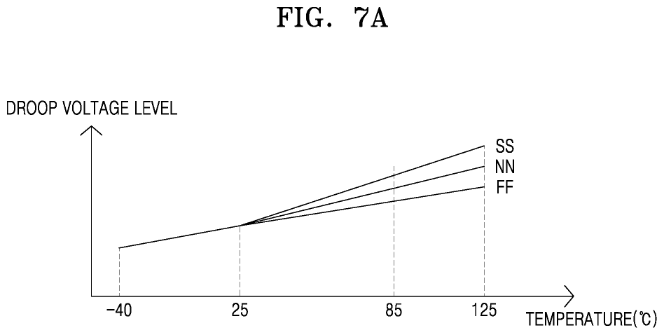

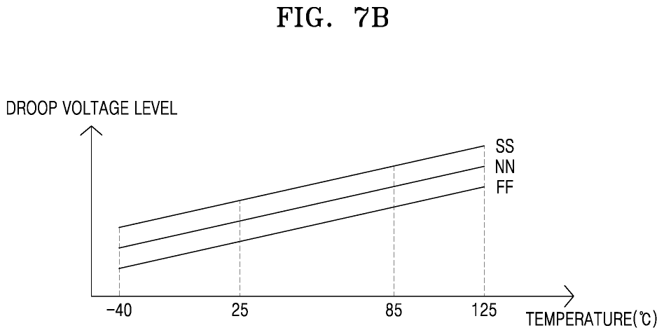

FIGS. 7A and 7B are graphs each showing a droop voltage level according to temperature characteristics of an element of the functional circuit 100 according to an embodiment.

Referring to FIGS. 7A and 7B, the horizontal axis represents temperature, and the vertical axis represents a droop voltage level of a supply voltage. Referring to FIGS. 1, 7A, and 7B together, a degree of droop of a supply voltage according to temperature characteristics may vary depending on element characteristics of the functional circuit 100. The element characteristics may be distinguished by a process corner of an element (e.g., a CPU or wafer) inside a system-on-chip. For example, the element characteristics may be divided into a slow process corner, a normal process corner, and a fast process corner. For example, FIG. 7A shows a droop voltage level optimized according to a process considering a gradient, and FIG. 7B shows a droop voltage level optimized according to a process considering an offset.

Referring to FIGS. 7A and 7B, when elements of the functional circuit 100 have a first element characteristic SS (e.g., when the elements of the functional circuit 100 correspond to a slow process corner), the droop voltage level may increase as the temperature of the system-on-chip increases.

When the elements of the functional circuit 100 have a second element characteristic NN (e.g., when the elements of the functional circuit 100 correspond to a normal process corner), the droop voltage level may increase as the temperature of the system-on-chip increases. As shown in FIGS. 7A and 7B, the droop voltage level corresponding to the second element characteristic NN may be less than the droop voltage level corresponding to the first element characteristic SS.

When the elements of the functional circuit 100 have a third element characteristic FF (e.g., when the elements of the functional circuit 100 correspond to a fast process corner), the droop voltage level may increase as the temperature of the system-on-chip increases.

For example, referring to FIG. 7A, at 25° C., the droop voltage levels of the first element characteristic SS, the second element characteristic NN, and the third element characteristic FF may be about the same, and at 85° C., the droop voltage level of the first element characteristic SS may be greater than the droop voltage level of the second element characteristic NN, and the droop voltage level of the second element characteristic NN may be greater than the droop voltage level of the third element characteristic FF. FIG. 7A shows a droop voltage level for each process considering an influence of gradient depending on temperature.

For example, referring to FIG. 7B, at 25° C., the droop voltage level of the first element characteristic SS may be greater than the droop voltage level of the second element characteristic NN, and the droop voltage level of the second element characteristic NN may be greater than the droop voltage level of the third element characteristic FF. FIG. 7B shows a droop voltage level for each process considering an influence of offset.

As shown in FIGS. 7A and 7B, the droop voltage level according to element characteristics of the functional circuit 100 may be linearly (or almost linearly) changed according to temperature changes. Accordingly, a reference voltage of a reference voltage generator may be optimized to a droop voltage level corresponding to temperature and process.

FIG. 8 is a diagram illustrating a method of adjusting a reference voltage according to an embodiment.

FIG. 8 relates to a method of adjusting the reference voltage VREF (that is, a minimum voltage Vmin) by comparing the supply voltage VSUP with the reference voltage VREF. A VSUP guard band may include VSUP droop and VSUP expected droop. When the VSUP guard band is determined, a minimum voltage Vmin of the reference voltage VREF may be determined. When the VSUP expected droop has significantly occurred, the supply voltage VSUP becomes lower than the minimum voltage Vmin, and thus, the functional circuit may malfunction.

The level of the supply voltage VSUP may be increased to prevent the malfunction of the functional circuit even when droop has occurred. That is, a plurality of reference voltages VREF may be output by the reference voltage generator 220 of FIG. 4. A voltage droop detection circuit may detect droop by comparing the plurality of reference voltages VREF with the supply voltage VSUP and generate a detection signal when droop has occurred. A clock modulation circuit may modulate the frequency of a clock signal by receiving the detection signal, and provide an adaptive clock signal to the functional circuit.

As shown in FIG. 8, a system-on-chip according to an embodiment may reduce power consumption of the functional circuit for a certain period of time by providing an adaptive clock signal having a lower frequency than before to the functional circuit when droop of a supply voltage has occurred. Accordingly, the system-on-chip may perform a stable operation as the drooped supply voltage is quickly recovered, and a guard band applied to the supply voltage may be reduced to reduce the overall amount of power consumed by the system-on-chip.

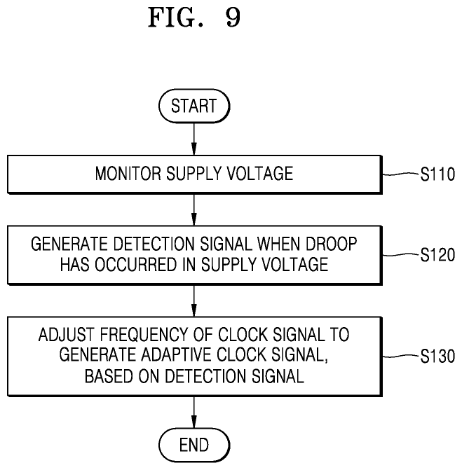

FIG. 9 is a flowchart illustrating an operating method of a system-on-chip according to an embodiment.

Referring to FIGS. 2 and 9, the voltage droop detection circuit 200 may monitor the supply voltage VSUP provided to the functional circuit 100 (S110).

The voltage droop detection circuit 200 may generate the detection signal FLAG when droop has occurred in the supply voltage VSUP (S120). For example, a case where droop has occurred in the supply voltage VSUP may refer to a case where the level of the supply voltage VSUP is less than the level of the reference voltage VREF.

Referring to FIGS. 1 and 9 together, the clock controller 400 may generate the adaptive clock signal ACLK by modulating the frequency of the clock signal CLK based on the detection signal FLAG (S130).

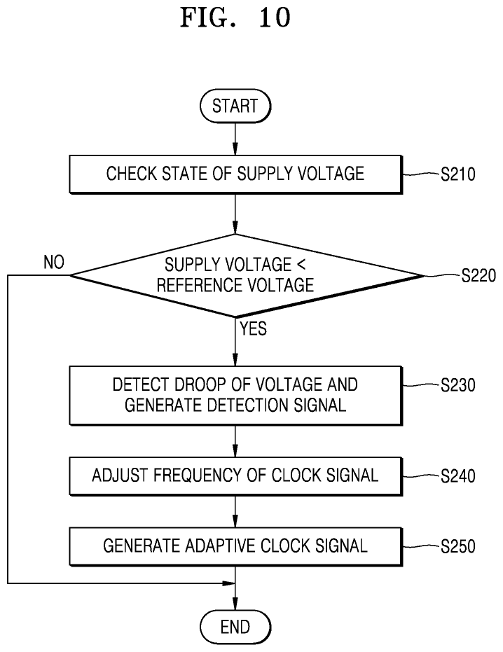

FIG. 10 is a flowchart illustrating an operating method of a system-on-chip according to an embodiment.

Hereinafter, as described above with reference to FIG. 2, it is assumed that the detection signal generator 230 may compare the supply voltage VSUP with each of the plurality of reference voltages VREF to generate the detection signal FLAG based on a comparison result.

Referring to FIGS. 1, 2, and 10, the voltage droop detection circuit 200 may check a state of the supply voltage VSUP (S210).

The detection signal generator 230 may compare the level of the supply voltage VSUP with the level of the reference voltage VREF (S220). When the level of the supply voltage VSUP is less than the level of the reference voltage VREF (YES at S220), the detection signal generator 230 may generate the detection signal FLAG (S230). For example, when droop has occurred in the supply voltage VSUP, the clock modulation circuit 420 may check a degree of droop of the supply voltage VSUP from the detection signal FLAG. The detection signal generator 230 may provide the detection signal FLAG to the clock modulation circuit 420.

The clock modulation circuit 420 may adjust the frequency of the clock signal CLK (S240). For example, referring to FIG. 5, the plurality of frequency dividers 421 and 422 may receive the clock signal CLK and divide the clock signal CLK by different division rates from each other to generate the first divided clock signal DCLK1 and the second divided clock signal DCLK2, which have different frequencies from each other.

The clock modulation circuit 420 may generate the adaptive clock signal ACLK (S250). For example, referring to FIG. 5, the multiplexer 423 may output any one of the first divided clock signal DCLK1 and the second divided clock signal DCLK2 as the adaptive clock signal ACLK, in response to the detection signal FLAG.

According to an embodiment shown in FIG. 10, when droop (voltage drop) has occurred in the supply voltage VSUP, the system-on-chip may detect the droop to change the frequency of the clock signal CLK, thereby allowing a functional circuit thereof to operate at a low voltage.

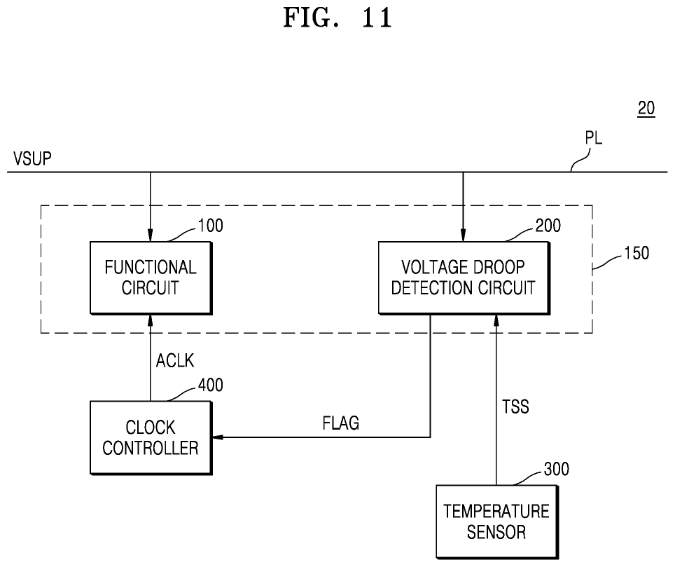

FIG. 11 is a block diagram illustrating a system-on-chip 20 according to an embodiment. For convenience of explanation, a further description of elements and technical aspects previously described with reference to FIG. 1 are omitted.

Referring to FIG. 11, the system-on-chip 20 may include the functional circuit 100, the voltage droop detection circuit 200, the temperature sensor 300, and the clock controller 400. Unlike FIG. 1, FIG. 11 shows a case where the functional circuit 100 and the voltage droop detection circuit 200 are included in the same block 150 instead of having separate configurations. For example, the voltage droop detection circuit 200 may be arranged inside the functional circuit 100, or the functional circuit 100 and the voltage droop detection circuit 200 may be arranged adjacent to each other in the block 150. As the functional circuit 100 and the voltage droop detection circuit 200 are arranged adjacent to each other, the voltage droop detection circuit 200 may quickly generate the detection signal FLAG indicating whether droop has occurred when the supply voltage VSUP falls below a reference voltage.

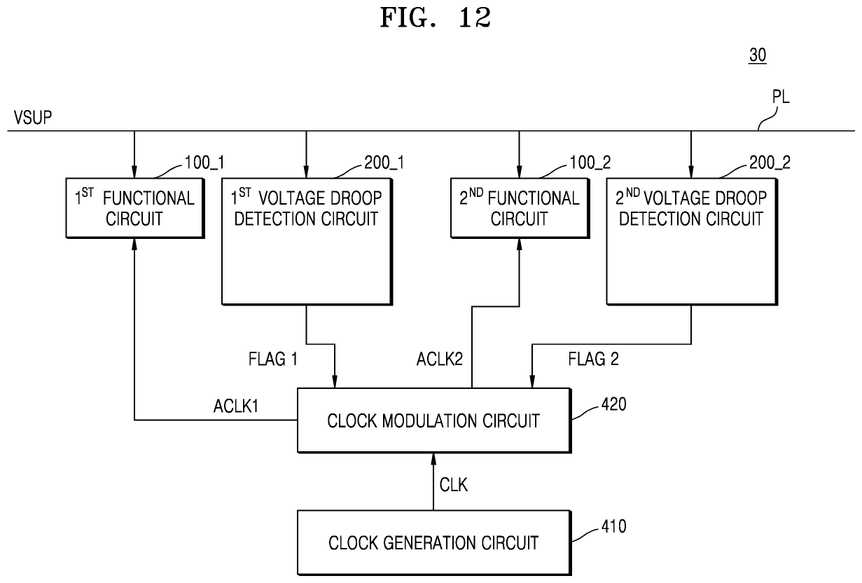

FIG. 12 is a block diagram illustrating a system-on-chip 30 according to an embodiment. For convenience of explanation, a further description of components and technical aspects previously described with reference to FIGS. 1 and 11 are omitted.

Referring to FIG. 12, the system-on-chip 30 may include a first functional circuit 100_1, a first voltage droop detection circuit 200_1, a second functional circuit 100_2, a second voltage droop detection circuit 200_2, the clock generation circuit 410, and the clock modulation circuit 420. The system-on-chip 30 may further include a temperature sensor.

The system-on-chip 30 shown in FIG. 12 may include a voltage droop detection circuit for each functional circuit, unlike the system-on-chips 10 and 20 of FIGS. 1 and 2.

The first functional circuit 100_1 and the second functional circuit 100_2 may perform processing operations by receiving the supply voltage VSUP. The first voltage droop detection circuit 200_1 and the second voltage droop detection circuit 200_2 may monitor the supply voltage VSUP and may respectively generate and provide detection signals FLAG1 and FLAG2 indicating whether droop of the supply voltage VSUP has occurred to the clock modulation circuit 420.

An embodiment as described with reference to FIG. 2 may be applied to the clock generation circuit 410 and the clock modulation circuit 420. For example, the clock modulation circuit 420 may receive the detection signals FLAG1 and FLAG2 and modulate the clock signal CLK to correspond to the detection signals FLAG1 and FLAG2 to generate first and second adaptive clock signals ACLK1 and ACLK2, and respectively provide the first and second adaptive clock signals ACLK1 and ACLK2 to the first functional circuit 100_1 and the second functional circuit 100_2.

In an embodiment, when a voltage droop degree of the first voltage droop detection circuit 200_1 is different from a voltage droop degree of the second voltage droop detection circuit 200_2, the frequency of the first adaptive clock signal ACLK1 may be different from the frequency of the second adaptive clock signal ACLK2.

FIG. 12 shows that the system-on-chip 30 includes two functional circuits (first and second functional circuits 100_1 and 100_2) and two voltage droop detection circuits (first and second voltage droop detection circuits 200_1 and 200_2), but the system-on-chip 30 is not limited thereto and may include any number of functional circuits and voltage droop detection circuits.

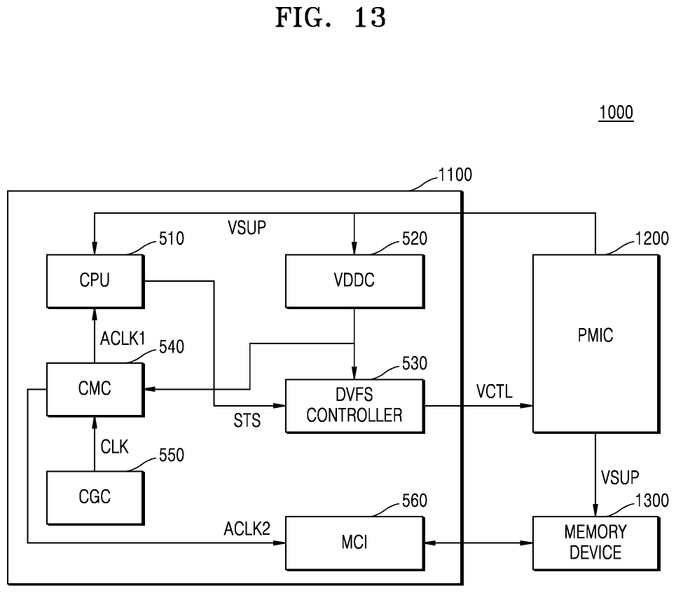

FIG. 13 is a block diagram illustrating a data processing system 1000 including a system-on-chip according to an embodiment.

Referring to FIG. 13, the data processing system 1000 may include an application processor 1100, a power management integrated circuit (PMIC) 1200, and a memory device 1300.

The data processing system 1000 shown in FIG. 13 may correspond to various types of computing systems, for example, a mobile system in which the application processor 1100 is employed.

The application processor 1100 may be implemented as the system-on-chip according to embodiments. The system-on-chip may include a system bus to which a protocol having a certain standard bus specification is applied, and may include various types of intellectual properties (IP) connected to the system bus. An advanced microcontroller bus architecture (AMBA) protocol of Advanced RISC Machine (ARM) may be applied as a standard specification of the system bus.

The application processor 1100 may include a central processing unit (CPU) 510, a voltage droop detection circuit (VDDC) 520, a DVFS controller 530, a clock modulation circuit unit (CMC) 540, a clock generation circuit (CGC) 550, and a memory controller interface (MCI) 560. The CPU 510, the VDDC 520, the DVFS controller 530, the CMC 540, the CGC 550, and the memory controller interface 560 may each constitute a functional circuit. Accordingly, the CPU 510, the VDDC 520, the DVFS controller 530, the CMC 540, the CGC 550, and the memory controller interface 560 may each correspond to the functional circuit 100 of FIGS. 1 and 11.

The CPU 510 may control various types of functional blocks in the application processor 1100. The CPU 510 may send and receive data access requests to/from the memory device 1300 from the outside of the data processing system 1000 through the memory controller interface 560. In an embodiment, by measuring the level of a supply voltage after applying the supply voltage to the CPU 510, it may be checked whether embodiments described with reference to FIGS. 1 to 12 are applied to the data processing system 1000. In an embodiment, by measuring the level of a supply voltage after applying the supply voltage and a clock signal to the CPU 510, it may also be checked whether embodiments described with reference to FIGS. 1 to 12 are applied to the data processing system 1000.

The CGC 550 may generate the clock signal CLK and provide the clock signal CLK to the CMC 540.

The CMC 540 may generate the first adaptive clock signal ACLK1 and the second adaptive clock signal ACLK2 based of the clock signal CLK, provide the first adaptive clock signal ACLK1 to the CPU 510, and provide the second adaptive clock signal ACLK2 to the MCI 560. For example, the CMC may modulate the frequency of the clock signal CLK based on the detection signal FLAG received from the VDDC 520 to generate the first adaptive clock signal ACLK1.

The VDDC 520 may correspond to the voltage droop detection circuit 200 shown in FIG. 1. The VDDC 520 may monitor the supply voltage VSUP provided to the CPU 510, and when droop has occurred in the supply voltage VSUP, the VDDC 520 may provide the detection signal FLAG indicating the occurred droop to the CMC 540 and the DVFS controller 530. The VDDC 520 may include the VDD controller 210, the reference voltage generator 220, and the detection signal generator 230, as shown in FIG. 3.

The DVFS controller 530 may provide a voltage control signal VCTL to the PMIC 1200 based on the detection signal FLAG, and the PMIC 1200 may adjust the level of the supply voltage VSUP based on the voltage control signal VCTL. The DVFS controller 530 may receive a state signal STS indicating an operating speed of the CPU 510 from the CPU 510. The DVFS controller 530 may determine or predict the operating speed of the CPU 510 and the memory device 1300 based on the state signal STS. The DVFS controller 530 may provide the voltage control signal VCTL reflecting the determined operating speed to the PMIC 1200.

The MCI 560 may provide a command to the memory device 1300 according to a request from the CPU 510. The MCI 560 may write data to the memory device 1300 or read data from the memory device 1300 according to the operation of the application processor 1100.

The memory device 1300 may be various types of semiconductor memory devices. For example, the memory device 1300 may be dynamic random memory (DRAM) such as double data rate synchronous dynamic random-access memory (DDR SDRAM), low power double data rate (LPDDR) SDRAM, graphics double data rate (GDDR) SDRAM, Rambus dynamic random-access memory (RDRAM), or the like.

The memory device 1300 may adjust the level of the supply voltage VSUP from the PMIC 1200 in response to a the voltage control signal VCTL and accordingly generate an internal voltage with the adjusted level of the supply voltage VSUP as an operating voltage. According to embodiments, the memory device 1300 may adjust the level of an operating voltage in advance before an operating speed is changed or before the frequency of the second adaptive clock signal ACLK2 provided from the MCI 560 is changed. According to embodiments, the memory device 1300 may variously set adjustment time points of the level of an operating voltage in correspondence to the change in operating speed.

The PMIC 1200 may provide the supply voltage VSUP to the application processor 1100 and the memory device 1300. The PMIC 1200 may provide supply voltages VSUP having different power levels to the application processor 1100 and the memory device 1300. The PMIC 1200 and the application processor 1100 may form separate system-on-chips or form a single system-on-chip.

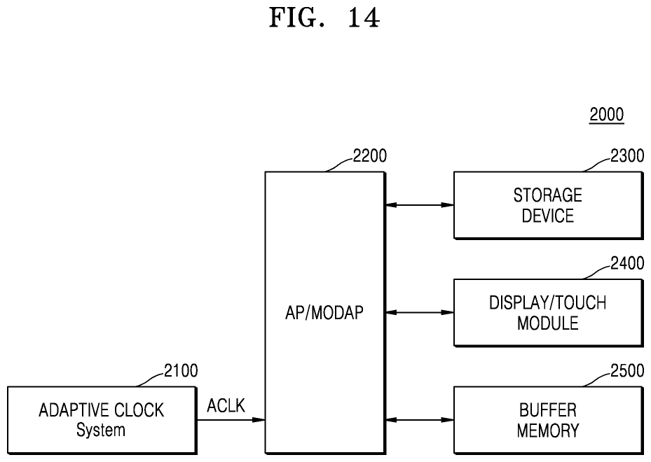

FIG. 14 is a block diagram illustrating a mobile system 2000 including a system-on-chip according to an embodiment.

Referring to FIG. 14, the mobile system 2000 may include an adaptive clock system 2100, a processor (e.g., an application processor (AP) or an integrated modem application processor (MODAP) 2200), a storage device 2300, a display/touch module 2400, and a buffer memory 2500. The mobile system 2000 may include, for example, a personal digital assistant (PDA), a portable computer, a web tablet, a wireless phone, a mobile phone, a digital music player, a memory card, or the like.

According to embodiments, the mobile system 2000 may further include a security chip. The security chip may be implemented to provide overall security functions. The security chip may include software and/or tamper resistant hardware, which allows for a high level of security, and may operate in cooperation with a trusted execution environment (TEE) of the processor 2200. The security chip may include an operating system (e.g., a native operating system (OS)), an internal data storage (e.g., a security storage device), an access control block that controls access to the security chip, security functional blocks that perform, e.g., ownership management, key management, digital signature, encryption/decryption, etc., and a firmware update block that updates the firmware of the security chip. The security chip may be, for example, a universal IC card (UICC) (e.g., USIM CSIM, and ISIM), a subscriber identity module (SIM) card, an embedded secure element (eSE), MicroSD, Stickers, or the like.

The adaptive clock system 2100 may be implemented as the system-on-chips 10, 20, and 30 shown in FIGS. 1 to 13. The adaptive clock system 2100 may be implemented to detect droop of a supply voltage of at least one power line, generate the adaptive clock signal ACLK according to a detection result, and provide the adaptive clock signal ACLK to the processor 2200.

The processor 2200 may be implemented to control the overall operation of the mobile system 2000 and wired/wireless communication. For example, the processor 2200 may be an AP or an MODAP. The processor 2200 may include the voltage droop detection circuit 200 described above with reference to FIGS. 1 to 13. Accordingly, droop of a supply voltage supplied to the processor 2200 may be improved, and the stability of the mobile system 2000 may be improved.

The storage device 2300 may include, for example, an embedded multimedia card (eMMC), solid state drive (SSD), a universal flash storage (UFS), or the like. The storage device 2300 may include at least one non-volatile memory device. The at least one non-volatile memory device may include, for example, NAND flash memory, vertical NAND (VNAND), NOR flash memory, resistive random-access memory (RRAM), phase change memory (PRAM), magnetoresistive random access memory (MRAM), ferroelectric random-access memory (FRAM), spin transfer torque random-access memory (STT-RAM), or the like. The storage device 2300 may store data input by the display/touch module 2400.

The display/touch module 2400 may display data processed by the processor 2200. The display/touch module 2400 may receive data input from a touch panel. A user may input data through the display/touch module 2400. In an embodiment, when the display/touch module 2400 receives data from a touch panel, the level of a supply voltage of the processor 2200 may be measured to check whether embodiments described above with reference to FIGS. 1 to 13 are applied to the mobile system 2000.

The buffer memory 2500 may store data utilized during processing operations of the mobile system 2000.

The mobile system 2000 according to an embodiment may detect droop in a supply voltage consumed by the processor 2200 and modulate the frequency of a clock signal to prevent droop in supply voltage of a power line. Accordingly, an operation of the mobile system 2000 may be stably performed and unnecessary power consumption may be reduced.

As is traditional in the field of the inventive concept, embodiments are described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, etc., which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions.

While the inventive concept has been particularly shown and described with reference to embodiments thereof, it will be understood that various changes in form and detail may be made therein without departing from the spirit and scope of the inventive concept as defined by the following claims.

1. A system-on-chip, comprising:
a functional circuit configured to receive a supply voltage and perform a processing operation;
a voltage droop detection circuit configured to monitor the supply voltage and generate a detection signal indicating whether a voltage droop has occurred;
a clock generation circuit configured to output a clock signal; and
a clock modulation circuit configured to receive the detection signal and the clock signal, generate an adaptive clock signal by modulating the clock signal to correspond to the detection signal, and provide the adaptive clock signal to the functional circuit,
wherein the voltage droop detection circuit comprises:
a voltage droop detection controller configured to control a reference voltage to remain constant;
a reference voltage generator configured to generate the reference voltage; and
a detection signal generator configured to generate the detection signal by comparing the reference voltage with the supply voltage.

2. The system-on-chip of claim 1, wherein the clock modulation circuit comprises:
a first frequency divider configured to divide a frequency of the clock signal and output a first divided clock signal;
a second frequency divider configured to divide the frequency of the clock signal and output a second divided clock signal; and
a multiplexer configured to select and provide any one of the first divided clock signal and the second divided clock signal to the functional circuit, in response to the detection signal.

3. The system-on-chip of claim 2, wherein the multiplexer is further configured to output any one of the first divided clock signal and the second divided clock signal as the adaptive clock signal.

4. The system-on-chip of claim 2, wherein a frequency of the first divided clock signal is less than a frequency of the clock signal, and
a frequency of the second divided clock signal is about equal to the frequency of the clock signal.

5. The system-on-chip of claim 2, wherein, when the detection signal indicates that the voltage droop of the supply voltage has been detected,
the multiplexer outputs and provides the adaptive clock signal to the functional circuit.

6. The system-on-chip of claim 2, wherein, when the detection signal indicates that the voltage droop of the supply voltage has not been detected,
the multiplexer provides the clock signal to the functional circuit.

7. The system-on-chip of claim 1, further comprising:
a temperature sensor configured to sense a temperature inside the system-on-chip and generate a sensing signal indicating a temperature state of the system-on-chip.

8. The system-on-chip of claim 7, wherein the clock modulation circuit is further configured to output any one of the clock signal and the adaptive clock signal, based on the sensing signal of the temperature sensor.

9. The system-on-chip of claim 7, wherein the clock modulation circuit is further configured to output the adaptive clock signal when the temperature inside the system-on-chip exceeds a reference temperature.

10. The system-on-chip of claim 1, wherein the voltage droop detection circuit is arranged adjacent to the functional circuit inside the system-on-chip.

11. The system-on-chip of claim 1, wherein the reference voltage generator comprises:
a band gap reference circuit configured to generate a band gap reference voltage;
a reference voltage buffer configured to receive the band gap reference voltage and output a digital-to-analog converter (DAC) reference voltage;
a DAC configured to convert the DAC reference voltage into an analog reference voltage; and
a buffer configured to output the analog reference voltage,
wherein the analog reference voltage is the reference voltage.

12. An operating method of a system-on-chip, comprising:
monitoring, by a voltage droop detection circuit included in the system-on-chip, a supply voltage,
wherein the supply voltage is received by a functional circuit included in the system-on-chip, and the functional circuit is configured to perform a processing operation;
comparing a level of the supply voltage with a level of a reference voltage;
generating a detection signal, based on a result of comparing the level of the supply voltage with the level of the reference voltage; and
adjusting a frequency of a clock signal, based on the detection signal.

13. The method of claim 12, wherein the detection signal is a signal indicating whether a voltage droop of the supply voltage has occurred, and
the detection signal is generated when the level of the supply voltage is less than the level of the reference voltage.

14. The method of claim 12, wherein adjusting the frequency of the clock signal comprises:
adjusting the frequency of the clock signal and outputting an adaptive clock signal, when the level of the supply voltage is less than the level of the reference voltage.

15. The method of claim 14, wherein outputting the adaptive clock signal comprises:
outputting a first divided clock signal obtained by dividing the frequency of the clock signal;
outputting a second divided clock signal obtained by dividing the frequency of the clock signal; and
selecting and outputting any one of the first divided clock signal and the second divided clock signal, in response to the detection signal.

16. The method of claim 15, wherein a frequency of the first divided clock signal is less than the frequency of the clock signal, and
a frequency of the second divided clock signal is about equal to the frequency of the clock signal.

17. The method of claim 12, further comprising:
sensing an internal temperature of the system-on-chip; and
generating a sensing signal indicating a temperature state of the system-on-chip.

18. A system-on-chip, comprising:
a first functional circuit configured to receive a supply voltage and perform a first processing operation;
a first voltage droop detection circuit configured to monitor the supply voltage and generate a first detection signal indicating whether a voltage droop has occurred;
a second functional circuit configured to receive the supply voltage and perform a second processing operation;
a second voltage droop detection circuit configured to monitor the supply voltage and generate a second detection signal indicating whether the voltage droop has occurred;
a clock generation circuit configured to output a clock signal; and
a clock modulation circuit configured to receive the first and second detection signals and the clock signal, generate a first adaptive clock signal and a second adaptive clock signal by modulating the clock signal to correspond to the first and second detection signals, respectively, and provide the first adaptive clock signal and the second adaptive clock signal to the first functional circuit and the second functional circuit, respectively,
wherein the first voltage droop detection circuit comprises:
a first controller configured to control a first reference voltage to remain constant;
a first reference voltage generator configured to generate the first reference voltage; and
a first detection signal generator configured to generate the first detection signal by comparing the first reference voltage with the supply voltage,
wherein the second voltage droop detection circuit comprises:
a second controller configured to control a second reference voltage to remain constant;
a second reference voltage generator configured to generate the second reference voltage; and
a second detection signal generator configured to generate the second detection signal by comparing the second reference voltage with the supply voltage to.

19. The system-on-chip of claim 18, wherein the first voltage droop detection circuit and the first functional circuit are arranged adjacent to each other inside the system-on-chip, and
the second voltage droop detection circuit and the second functional circuit are arranged adjacent to each other inside the system-on-chip.

20. The system-on-chip of claim 18, wherein the clock modulation circuit comprises:
a first frequency divider configured to divide a frequency of the clock signal and output a first divided clock signal;
a second frequency divider configured to divide the frequency of the clock signal and output a second divided clock signal; and
a multiplexer configured to select and output any one of the first divided clock signal and the second divided clock signal as an adaptive clock signal to the first and second functional circuits, in response to the first and second detection signals.

21. (canceled)
